(19) United States
(12) Patent Application Publication
(10) Pub. No.: US 2008/0154857 A1
(43) Pub. Date: Jun. 26, 2008

(54) Method of maintenance of dependent variables, and a semantic module for performing the same

(76) Inventor: Haithem Derouiche, Erlangen (DE)

Correspondence Address: HARNESS, DICKEY & PIERCE, P.L.C., P.O.BOX 8910, RESTON, VA, 20195, US

(21) Appl. No.: 11/643,700

(22) Filed: Dec. 22, 2006

(51) Int. Cl. G06F 17/30

(52) U.S. Cl. 707/3; 707/100

(57) ABSTRACT

Example embodiments of the present invention relate to maintenance of the dependencies between variables of equipment in a system, and semantic modules performing the same. According to at least one example embodiment, a semantic module for maintaining dependencies between variables of a user equipment may include a database to store the variables and information correlating to the dependencies between the variables, an interface to receive at least one proposed change to at least one of the variables, and a decision module to determine whether the at least one proposed change to the at least one of the variables is acceptable.

### FIELD

Embodiments of the application are generally directed to maintenance of variables in systems.

### DESCRIPTION OF THE CONVENTIONAL ART

Conventionally, software systems may use preset structures for the configuration of components and user equipment. Users of such software systems may not have the option of adapting the preset structures to the sequence of operating steps, the spatial structures, or the organizational structures which the users' require. Users may only have the option of adapting operating sequences, space, or organizational structures to the given configuration structures of the software system.

Systems vary widely and may include a plurality of variables. These variables may often have complex relationships which may involve system-wide dependencies or various interdependencies with other variables.

FIG. 1 illustrates a conventional system 10. For example, the system 10 may represent a typical personal computer (PC). With regard to a typical personal computer (PC), there may be a block of dependent configuration settings (i.e., variables) for a monitor or other user equipment 12. These settings may include but are not limited to vertical frequency, horizontal frequency, refresh frequency, etc. The vertical and horizontal frequency may be dependent in that only certain vertical frequencies will work for a given horizontal frequency. The converse may be true as well. For example, only certain horizontal frequencies will work for a certain vertical frequency.

The dependencies in this example appear at first glance to be simple. However, the dependencies may extend from horizontal and vertical frequencies to refresh frequencies and gamma settings as well. Furthermore, the horizontal and vertical frequencies, refresh frequencies, and gamma settings may further be dependent on the brightness and contrast settings relayed to the monitor. As such, there is a complicated network of semantic relationships between the variables.

In the system 10, a user interface 11 in the PC or the user of the PC must take these relationships into account. For example, the user interface 11 may be used by a plurality of users with access to the system 10. Each user of the plurality of users may require different configurations for the user equipment 12. The user interface 11 must then keep track of the values desired for the user equipment 12, by each user of the system 10, and must then take into consideration the complicated network of dependencies between the variables.

For instance, if a particular user of the system 10 wishes to alter a variable of the user equipment 12, the user interface 11 must transmit the new variables for the particular user of the system 10 to the user equipment 12. Such a transmission may be facilitated through a communication channel 14 to the user equipment 12. However, if the newly altered variables violate the dependencies and sensitive semantic relationships necessary for operation of the user equipment 12, the user equipment 12 may malfunction and/or deteriorate, causing undesirable operation for the users of the system 10. Furthermore, such malfunctions may disable communication (e.g., from the user equipment 12 to the user interface 11 through a channel 13) between the user equipment 12 and the user interface 11, thereby preventing the user interface 11 from receiving information regarding the malfunction or violation of the semantic relationships.

Such problems become more complicated in systems with a plurality of users. For example, the relationships may change for each user, thereby exponentially increasing the complexity of the network of semantic relationships system wide.

Furthermore, when the nature of the relationships between variables changes based on newer and/or different hardware, for example, an upgrade to a LCD monitor from a Cathode Ray tube (CRT), every semantic relationship and dependency must be considered by the user interface 11 such that the system 10 remains operable. Such an update is complicated in that at least the software or user interface programmers may not be fully capable of understanding the new semantic relationships, or may not have sufficient information regarding the new semantic relationships to facilitate the change easily.

Similarly, in systems with multiple components having many semantic and/or dependent relationships between variables, the user interface must consider all semantic interconnections and relationships for stable altering of the variables. As such, if a user wishes to modify a variable (e.g., monitor setting), the user interface must take into account all other settings, which may be dependent on the variable being altered by the user. The user interface may utilize logical connections within the user interface representing the semantic relationships between variables to attempt to maintain system integrity. However, as discussed above, the network of relationships is complicated and cumbersome.

For example, the user interface may represent semantic relationships using hierarchical structures representing the abstraction of users for the system. Therefore, for an increasing number of configuration data (e.g., variables) and hierarchical structures, the degree of complexity increases exponentially.

### SUMMARY

In order to make the semantic and/or dependent relationships transparent to a user interface, and to leave these relationships and responsibility of these relationships to an entity more familiar and equipped to handle them, the inventor has discovered that semantic modules, independent of the user interface, may be used to maintain the dependencies and/or semantic relationships.

Example embodiments of the present invention may provide maintenance of dependent variables in systems. For example, example embodiments may provide methods of maintaining the dependencies between variables of equipment in a system, and semantic modules performing the same.

According to at least one example embodiment, a semantic module for maintaining dependencies between variables of a user equipment may include a database, an interface and a decision module. The database may store the variables and information correlating to the dependencies between the variables. The interface may receive proposed changes to the variables. The decision module may determine whether the proposed changes to the variables are acceptable.

According to at least one example embodiment, a method of maintaining dependencies between variables of a user equipment may include receiving proposed changes to the variables of the user equipment, searching a database for information correlating to the dependencies of the variables, and determining whether the received proposed changes to the variables are acceptable, based upon the information searched from the database.

According to at least one other example embodiment, a system may include a plurality of semantic modules for maintaining dependencies between variables of a plurality of user equipment. Each semantic module of the plurality of semantic modules may include a database to store the variables and information about the dependencies between the variables, an interface to receive proposed changes to the variables, and a decision module to determine whether the proposed changes to the variables are acceptable or not. The system may further include a user interface. The user interface may include a back end portion and a front end portion. The front end portion may be arranged to communicate with the back end portion, and the back end portion may be arranged to communicate with the plurality of semantic modules.

### BRIEF DESCRIPTION OF THE DRAWINGS

The present invention will become more fully understood from the detailed description of example embodiments given herein below and the accompanying drawings, wherein like elements are represented by like reference numerals, which are given by way of illustration only and thus are not limiting of the present invention, wherein:

FIG. 1 illustrates a conventional system;

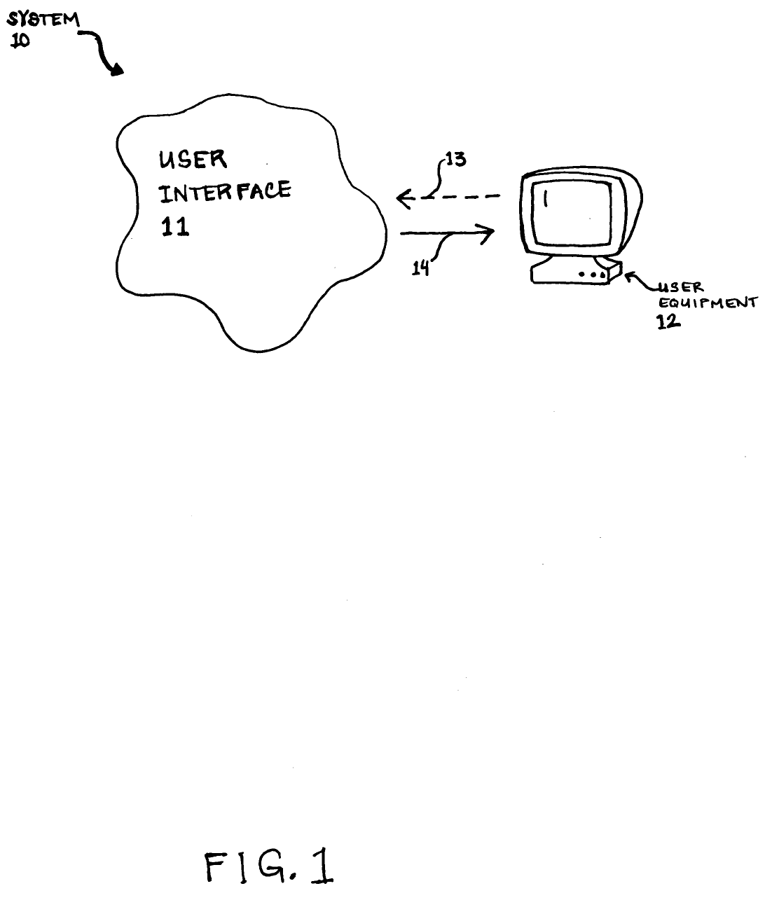

FIG. 2 illustrates a system including a semantic module, according to an example embodiment;

FIG. 3 illustrates a semantic module, according to an example embodiment;

FIGS. 4A and 4B illustrate hierarchical structures, according to an example embodiment;

FIGS. 5A and 5B illustrate hierarchical structures, according to an example embodiment;

FIG. 6 illustrates a system including a semantic module, according to an example embodiment;

FIG. 7 illustrates a system including a plurality of semantic modules, according to an example embodiment; and

FIG. 8 illustrates a method of maintaining dependencies between variables, according to an example embodiment.

### DETAILED DESCRIPTION EXAMPLE EMBODIMENTS

Detailed illustrative embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Hereinafter, example embodiments will be described with reference to the attached drawings. In at least one example embodiment, a semantic module is used for maintaining dependencies between variables of a user equipment. The semantic module includes a first database to store the variables and information correlating to the dependencies between the variables; an interface to receive at least one proposed change to at least one of the variables; and a decision module to determine whether the at least one proposed change to the at least one of the variables is acceptable.

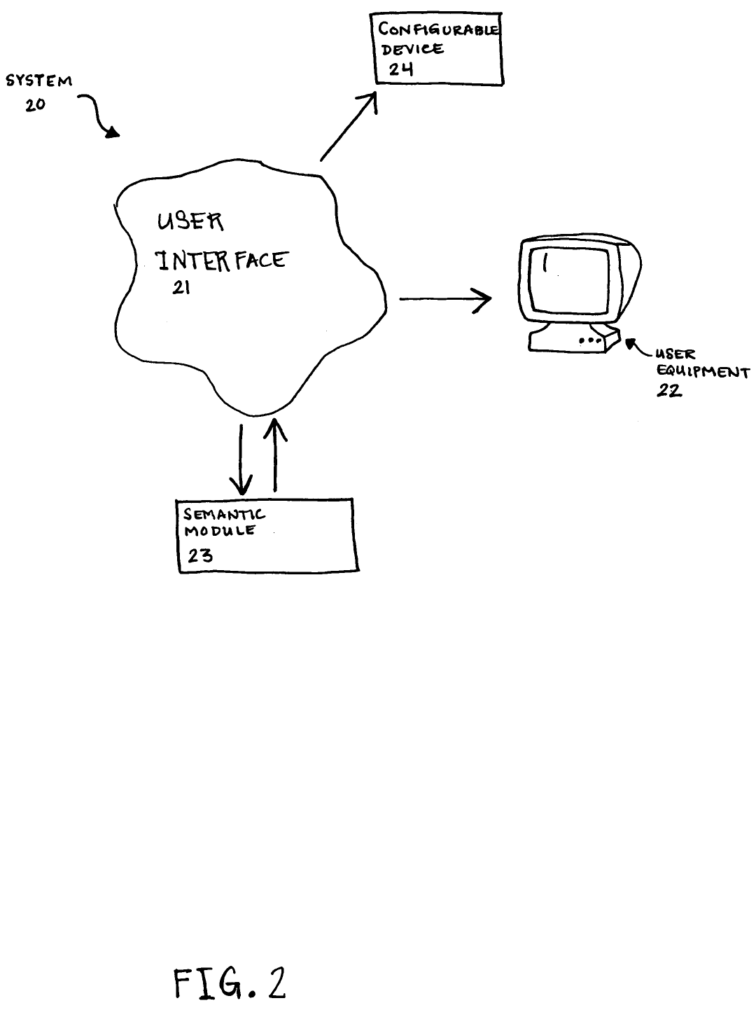

FIG. 2 illustrates a system including an example embodiment of a semantic module. The system 20 may include a plurality of devices such as a configurable device 24 and/or a user equipment 22. The system may further include a semantic module 23 (and/or a plurality of semantic modules).

For example, a plurality of users may have access to the system 20. A user may be considered to have access to the system when the user is able to “log in” or set up an account on the system. However, the application and example embodiments thereof should not be limited to only systems where user's can “log on”. For instance, any system with configurable settings and/or variables could similarly be used. For example, an automobile with different drivers, a large computer network with individual user-specific terminals, or any other suitable system may be used.

The user equipment 22, for example, may be a computer monitor or other such configurable device. Hereinafter, the user equipment 22 will be described as a monitor 22 for ease of description and brevity, although it will be understood that other user equipment could be used as well. The user interface 21 may be in communication with the monitor 22, either one-way through simply transferring video information, or two-way by both sending and receiving information to and from the monitor 22.

A user of the system 22 may wish to alter or customize some variable on the system. For example, the user may wish to slightly increase the refresh frequency of the monitor 22. As discussed previously, the refresh frequency of the monitor 22 may be dependent on any number of other variables including the horizontal and vertical frequencies for example. The user may, for example, open or start a configuration user interface within the user interface 21 (not shown) to enable changes to the refresh frequency of the monitor 22. The configuration user interface may prompt the user to enter the proposed changes to the variables of the monitor 22.

Subsequently, the user would enter or input the proposed changes to the configuration user interface. The configuration user interface may, following receipt of proposed changes of the variables, pass the proposed changes to the variables to the semantic module 23. The semantic module 23 may search a database or other storage structure for information correlating to the dependencies between the variables. The semantic module 23 may further determine whether the proposed changes violate the dependencies and/or semantic relationships of the variables of the monitor 22.

For example, the semantic module may determine whether the proposed increase in refresh frequency of the monitor 22 would allow the monitor 22 to function properly with the current values of the other variables for the monitor 22 (e.g., vertical frequency, horizontal frequency, etc.). In at least one example embodiment, the semantic module 23 may determine whether the proposed changes are valid and pass such information to the user interface 21.

In determining whether the proposed changes are valid, for example, the semantic module 23 may contain input ports and output ports for receiving the proposed changes. For example, the input ports and output ports may be communication channels. By proposing at least one change in the monitor settings (for example), the user interface 21 may send the data to the semantic module 23 through the input ports. The semantic module 23 may check the proposed change against defined or determined constraints necessary for operation of the monitor to determine if the proposed change violates the constraints. The result will be sent to the user interface 21 through the output ports. For example, the result may be whether changes are acceptable or not, and/or the values of variables after the changes take affect. Subsequently, the data would be displayed, for example, to the user through the user interface 21 and/or simply stored as valid or invalid changes.

For example, the semantic module 23 may output information representing the valid values for the variables of the monitor 22 to the user interface 21, such that the user interface 21 may refresh. Such a refresh would alert the user that the proposed changes are valid, enabled, etc.

With regard to the defined and/or determined constraints, within a semantic module 23, the constraints for variables set by the developer of the semantic module 23 may be stored. The semantic module 23 evaluates the proposed changes coming through the input port with the defined and/or determined constraints and outputs the result using the output ports. The constraints may be represented (for example) using mathematical equations, algebraic constructs, and/or other logical constructs (e.g., Frequency=Package Size/2).

However, it should be understood that semantic modules 23 are not limited to computer monitors and specific user equipment. Example embodiments are also applicable elsewhere, for example to networks and/or communication systems having interdependent variables, and/or variables with semantic relationships.

For example, semantic dependencies may also exist in an application which sends/receives data through a network channel. In order to successfully utilize the network channel, the application may need to be configured with the size (for example) of the data/packets to send, the channel type, and/or the frequency of sending the data/packets to achieve a certain speed and/or desired operability. These variables may correlate with the application which receives the data.

The application which receives the data may have to be able to support the amount of data/packets sent, speed of transmission, and/or frequency of transmission, for example. Therefore, the semantic relationships extend beyond just the application sending the data, and the network channel used for transmission, but also may extend to the application receiving the data as well.

Furthermore, each new installation in a system may contain default values. As an example, the following values may be used: DataSize=100 bytes, Frequency=50 Packets/s and Channel=TCP/IP. For this example, if one of these values is changed, then the other two need to be adapted to assure data transmission on the network channel is successful based on the relationship Frequency=DataSize/2. The semantic modules 23 may assist a service technician or administrator proposing changes by correcting wrong input data and/or providing feedback with regards to the acceptability of the proposed changes. For example, if an administrator sets DataSize=1000 bytes, then the administrator should adapt the Frequency and channel type as well.

By only setting DataSize, the administrator is making, from the syntax point of view, a correct setting, but the change is semantically wrong. In this example, the semantic module 23 would give the administrator feedback that the default values of the frequency and channel type need to be changed for this network to maintain correct functionality and/or operability.

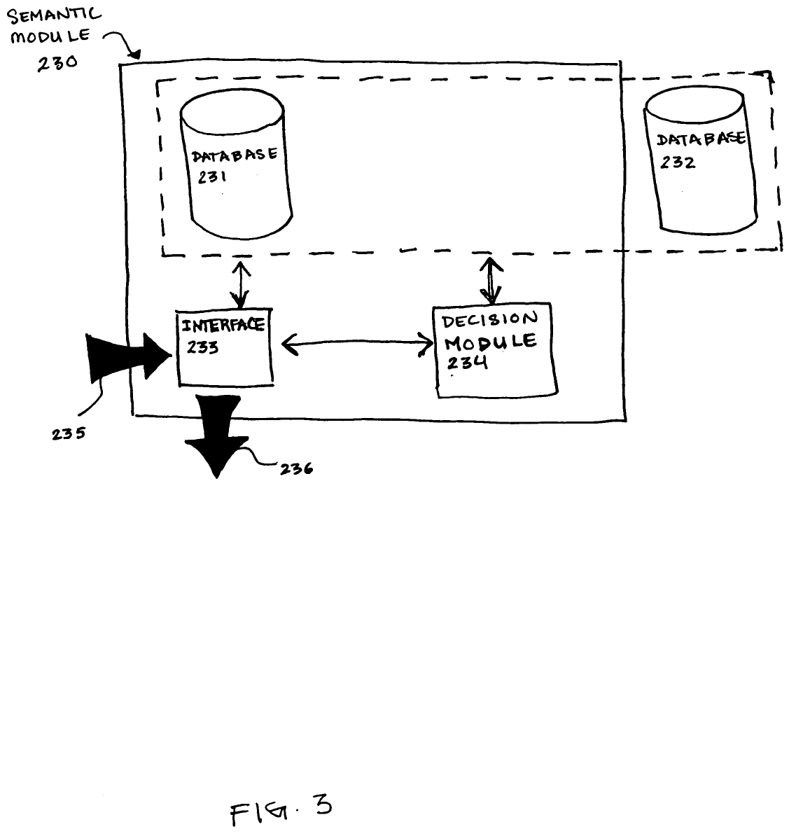

FIG. 3 illustrates a semantic module 230, according to an example embodiment. The semantic module 230 may include an interface 233 and a decision module 234. The semantic module 230 may enable inward communication through a channel 235 and outward communication through a channel 236. For example, the channels may be virtual communication channels in a memory system, data passed through software communication such as inputs and outputs in a software module, physical communication channels such as cables or connectors, or any suitable device/module for communication with the semantic module 230, depending on the particular implementation of the semantic module 230.

Such devices/modules for communication are well understood in the art, and may be relatively easily to implement by one of ordinary skill in the art. As such, detailed discussion with regards to particular implementations of communication with the semantic module will be omitted herein for the sake of brevity.

The semantic module 230 may further include a database 231. For example, the database 231 may store values for a system and/or information correlating to relationships and dependencies of variables.

The databases 231 may include any type of database where information regarding the semantic relationships and/or variable dependencies can be stored. For example, a system may include relational databases where the organization structure and semantic relationships are described in tables which are referenced with keys or on files. If the data is stored in files, the semantic relationships may be stored as references between files and/or as a reference within the files itself. As an alternative to a relational database, an object oriented database, or any other database may be used.

Furthermore, although described above as including a database 231, the semantic module 230 may alternatively communicate with a database 232 external to the semantic module 230. For example, the database 232 may be substantially similar to the database 231. As such, detailed discussion will be omitted herein for the sake of brevity.

Similarly, although described above as including the database 231, the semantic module 230 may alternatively both include the database 231 and include an external database 232. This may facilitate greater abstraction of semantic relationships within the system. For example, either database may store information correlating to semantic relationships and/or dependencies between variables.

The decision module 234 may be in communication with or may be able to communicate with the interface 233. For instance, as proposed changes are input through channel 235, the interface 233 may pass the proposed changes to the decision module 234.

The interface 233 may receive proposed changes to variables, and may direct or request search of the database 231 and/or 232 for information correlating to the dependencies between the variables. For example, the interface 233 may receive proposed changes to variables, and may present these variables for search in the database, such that information correlating directly to these variables and all variable dependent thereon be searched and retrieved from the database.

Although the semantic module 230 has been described as including an interface 233 to search or request a search of the database 231 and/or 232, the decision module or even an additional module (not shown) could also provide such functions.

Searching of the database 231 and/or 232 may include identification of the variables with proposed changes, retrieval of the variables, retrieval of values of variables, and/or identification of a set of variables dependent on the proposed changes. For example, if a proposed change of a refresh frequency of a monitor is input to the semantic module 230, searching for variables of the computer monitor may return the vertical and horizontal frequencies, the refresh frequency, and the gamma factor for the monitor, and may identify that all four variables are dependent on the proposed changes to the refresh frequency of the monitor.

Upon successful query of information correlating to dependencies and/or semantic relationships between variables, the decision module 234 may determine if the proposed changes are valid.

For example, the decision module 234 may temporarily change the values of the variables. Such a change may be made without communicating the change to any user equipment, solely to test the changes. For example, the decision module 234 may insert the values of the proposed values into a mathematical function describing the relationship between the variable, and obtain a result there-from. The mathematical function may include, for example: horizontal frequency≧refresh frequency. In this example, the decision module 234 may insert the proposed change to the refresh frequency into the mathematical function describing a relationship, and obtain the result. If the proposed change violates this relationship, the decision module 234 may determine that the change is invalid.

Although the decision module 234 has been described in context of only a single mathematical function, it will be understood that any mathematical function could just as easily be used. Actually, many different mathematical functions, of varying complexity, may be necessary to adequately describe the semantic relationships between variables in a system. Therefore, all such situations are considered to be within the scope of the application, including the example set forth above.

Upon determining whether the proposed changes to the variable are acceptable or not (i.e., valid or invalid), the decision module 234 may pass such information to the interface 233. The interface 233 may transmit the result of the determination to an outside user interface (not shown) through an outward communication channel 236. Similarly, the interface 233 may update the database 231 and/or 232 based on the determination, and/or may output all new variable values based on the proposed changes on the outward communication channel 236.

Although example embodiments have been described particularly with reference to a system including configurable user equipment, other systems and/or configurations are applicable as well. For example, software systems employed in companies may have a central database or system controlling information for many user terminals. Such central systems and databases may be abstracted into a form of hierarchy representing a sectioning of the users of the central systems.

Hereinafter, an example hierarchy with reference to a hospital will be used to describe an example embodiment of the application. It will be understood that this example is for the purpose of conveying the concept employed in example embodiments, and should be construed as illustrative and should not be construed as limiting.

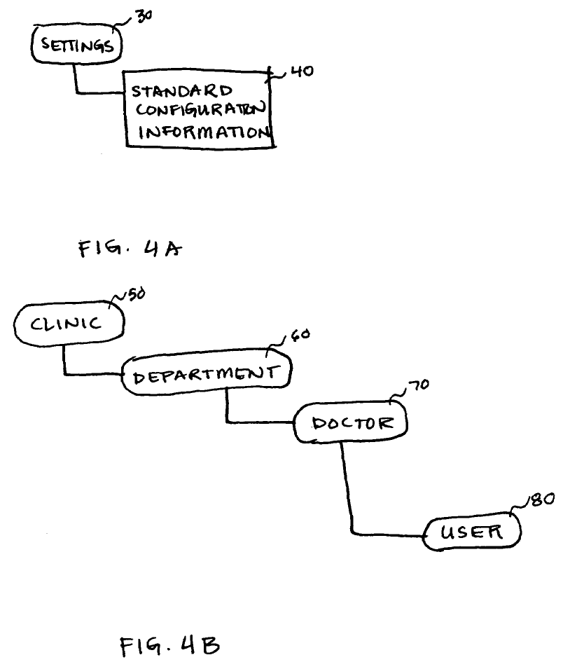

FIGS. 4A and 4B illustrate hierarchical structures, according to an example embodiment. With reference to FIG. 4A, a system may have settings 30 which are initialized to a factory default and/or include standard configuration information 40 relating to the system. For example, such standard configuration information 40 may include a list of variables and their default values, which may be in accord with existing semantic relationships between the variables. The default values may have been tested in a factory producing the system, or may have been adjusted by a service technician very familiar with the system.

With reference to FIG. 4B, the system, upon arrival or deployment at a location, may be configured for several different levels of users. For example, there may be a separation of offices in a hospital. The offices may include for example, the clinic, the pharmacy, and the outpatient center. As such, the system may be configured to store particular values for the variables of the system, depending on the office using the system.

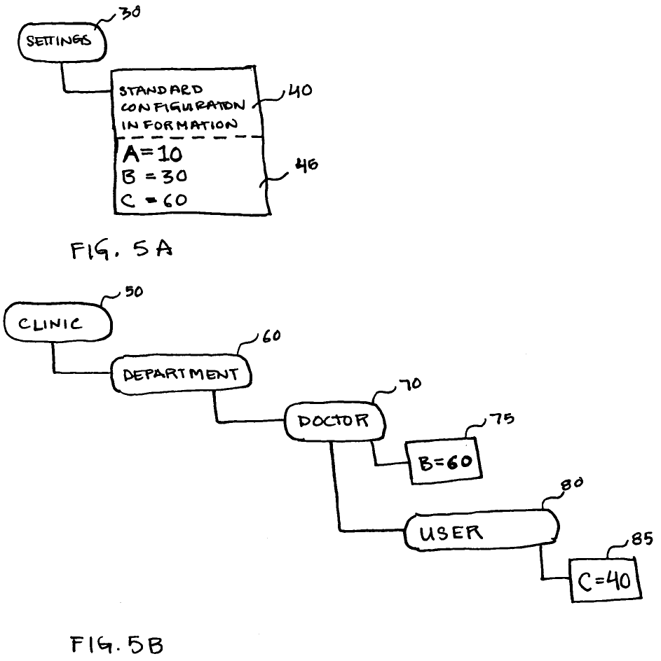

The clinic 50 may include different departments. A department 60 of the different departments may include different doctors, for example. Similarly, a user 80 of the system may be a doctor 70 belonging to the department 60 of the clinic 50. The user 80 may require a certain levels of access to the system, to ensure the user 80 is able to access all of the resources necessary for proper care of patients. The levels of access to the system may be represented by three (for example) interdependent variables A, B, and C. The variables, and their possible alteration or proposed changes, will be described with reference to FIGS. 5A and 5B.

FIGS. 5A and 5B illustrate hierarchical structures, according to an example embodiment. The variables A, B, and C, may have values included in the standard configuration information 40. In this example, the variables values of the variables may be stored as A=10, B=30, and C=60, in a partition 45 of the standard configuration information 40. For example, an existing semantic relationship between the variables A, B, and C, may be represented by the mathematical function A+B+C=100. If any or all of the variables A, B, and C are altered (e.g. via a variable change that is proposed) such that this relationship becomes invalid, the system may become unstable or inoperable.

For example, the group doctor 70 of department 60 may desire a variable B equal to 60. Furthermore, the user 80 of the group doctor 70 may desire a variable C equal to 40. For example, the user 80 may not require any value for variable A, and thus may not propose any changes to the variable A. Therefore, user 80 proposes at least one variable change wherein A=10 (standard setting), B=60, and C=40. As proposed by the user 80, the variables A, B, and C violate the semantic relationship A+B+C=100 of the system. As such, if such variable changes were allowed, the system may become unstable or inoperable. However, upon employing a semantic module of an embodiment of the present application for maintenance of the dependencies of these variables, the problem can be remedied.

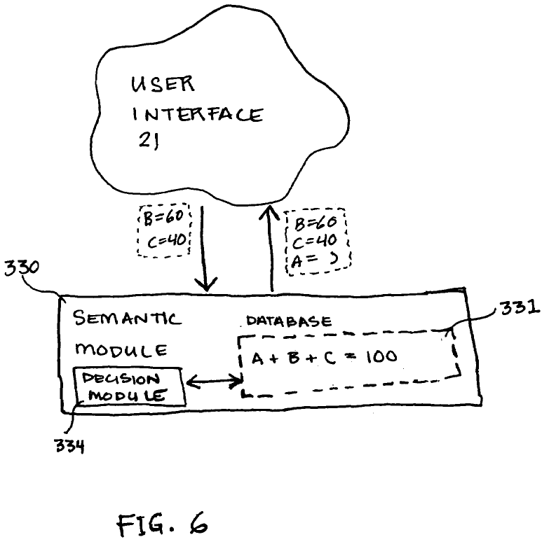

FIG. 6 illustrates a system including a semantic module, according to an example embodiment. The semantic module 330 may be in communication with the user interface 21 of the system used by user 80 of FIG. 5B. The user 80 may enter at least one the proposed change to variable C in the user interface 21. The user interface 21 may also receive or have stored information regarding user 80 belonging to group doctor 70, and therefore, also requiring variable B to have at least one proposed change. The user interface 21 may output the proposed changes to the variables to the semantic module 330.

The semantic module 330 may search database 331 for information correlating to the variables. For example, the searching may include searching for variables B and C and any variables which are dependent upon either or both of variables B and C. The searching would return the relationship A+B+C=100. Subsequently, the decision module may determine if the at least one proposed change, to at least one of the variables, violates this relationship. The decision module 334 may further determine that if B=60, C=40, and A+B+C=100, then A=0 and not 10 as stored in the standard configuration settings information (not shown). If this occurs, the semantic module 330 may simply output information representing the determination that the at least one proposed change, to at least one of the variables, violates the relationship (For example, the semantic module 330 may output such information as a warning, flag, or any other form of information useful to the user interface 21). Further, although not preferred, the determination may also be output is the change is acceptable, if desired. The semantic module 330 may alternatively and/or further output information representing that the variable A may be altered to 0 to maintain the relationship, and subsequently, maintain a stable system.

With regard to information relating to the standard configuration settings, the user interface 21 may output such information to the semantic module 330, or the semantic module 330 may obtain this information on its own accord. For example, the semantic module may search for this information in a second database (not shown) common to the user interface 21.

Example embodiments are not limited to systems including a single semantic module, however. A system may include a plurality of semantic modules for maintaining dependencies between variables of a plurality of user equipment. Each semantic module of the plurality of semantic modules may include a first database to store the variables and information correlating to the dependencies between the variables, an interface to receive at least one proposed change to at least one of the variables, and a decision module to determine whether the at least one proposed change to the at least one of the variables is acceptable. The system may further include a user interface including a back end portion and a front end portion, wherein the front end portion is arranged to communicate with the back end portion, and the back end portion is arranged to communicate with the plurality of semantic modules.

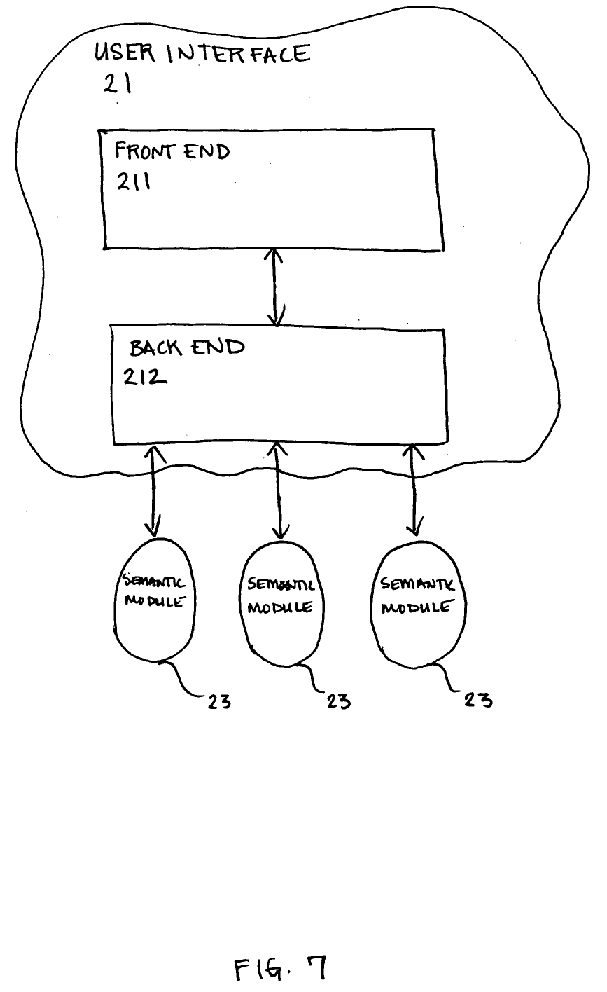

FIG. 7 illustrates a system including a plurality of semantic modules, according to an example embodiment. As illustrated in FIG. 7, a user interface 21 may be in communication with a plurality of semantic modules 23. In at least one example embodiment, the user interface 21 includes a back end 212 and a front end 211. The back end 212 of the user interface 21 may be in communication with the plurality of semantic modules 23. For example, the back end 212 may be the portion of the user interface 21 not directly accessible by a user. The back end 212 may include program threads, and/or may evaluate any information relayed from a front end 211 including but not limited to selections, mouse clicks, et cetera.

In contrast, the front end 211 may be directly accessible by the user. For example, the front end 211 may include any combination of the familiar check-boxes, radio buttons, and/or input fields of typical user interfaces. The front end 211 may be in communication with the back end 212, thereby facilitating the exchange of proposed changes from the user to the semantic modules 23. As the proposed changes are passed to the semantic modules 23, the semantic modules 23 may determine if the proposed changes are acceptable and/or whether the proposed changes are consistent with the semantic relationships and/or dependencies of the variables. The determination may then be passed to the back end 212, and subsequently, to the front end 211 such that the changes may be reflected in the user interface 21.

Further, although example embodiments have been described particularly with reference to a system, methods involving the methodology of the system are applicable as well. At least one example embodiment includes method of maintaining dependencies between variables of a user equipment.

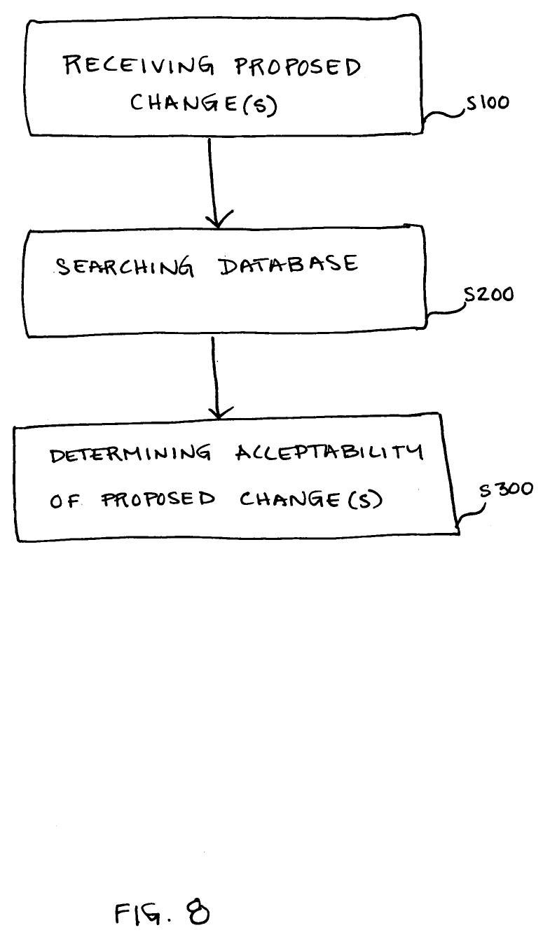

FIG. 8 illustrates an example embodiment of a method of maintaining dependencies between variables, according to an example embodiment. With regard to FIG. 8, a method according to example embodiments may include receiving at least one proposed change to at least one of the variables of the user equipment (S100), searching a database for information correlating to the dependencies of the at least one variable (S200) for which the at least one proposed change is received, and determining whether the at least one received proposed change to the at least one variable is acceptable based upon the information searched from the database (S300).

S100 may further include receiving the at least one proposed change through an inward communication channel. For example, a communication channel may be active between a semantic module and a user interface, and/or may facilitate transferring proposed changes from a user such that the method may access them.

S200 may include locating stored values for the variables in the database and/or identifying a set of variables dependent on the at least one proposed change. As described above in the example embodiment with regard to the clinic, the semantic module may require information regarding all variables to successfully determine if the semantic relations are violated. As such, in example embodiments, a method of searching a database may include retrieving any information pertinent or correlating to the dependencies between variables.

For example, the information correlating to the dependencies of the variables may be a set of relationships between the variables. These relationships may be a tie of values, such as the relationship between the vertical and horizontal frequencies of a monitor for example.

Furthermore, the information correlating to the dependencies of the variables may be functions of the values of the variables. For example, the functions may be mathematical expressions and/or functions relating the values of the variables such that a determination can be made as to whether proposed changes are acceptable or not. In the example embodiment of a user in a clinic, the semantic relationship is represented by the function A+B+C=100.

S300 may include replacing, temporarily, one or more of the variables with one or more of the proposed changes to the variables or proposed changed variables. In the example set forth above, the method may replace variable A and B with proposed changes and may further include determining if the result of the changes violates the set of relationships between the variables. Take proposed changes of A=25 and B=25, for example. Depending on the value of the variable C stored or retrieved from the database, the function 25+25+C=100 may be acceptable. An acceptable value for this example is C=50. If the stored value of C is not 50, the relationship is violated.

S300 may also include admitting the replaced variable(s) based on the determination. In the example set forth above, if the stored value of C is 50, then the proposed changes of A=25 and B=25 are valid (i.e., acceptable), and may be admitted into storage.

It should be understood that the general method steps S100, S200 and S300 and the method step variations of S100, S200 and S300 described above may be used in any combination and/or permutation thereof.

Methods as set forth in example embodiments may be implemented as processes in a system, or may be implemented as processes in a semantic module.

Semantic modules have been disclosed. Semantic modules may provide a unique operation such that any proposed changes to variables will be input to the semantic module, and verified to be acceptable or not.

The semantic module may keep track of all dependencies for a particular portion of the system. For example, a monitor's configuration settings may be maintained by a semantic module exclusively for the monitor. This monitor semantic module may be easily updated with new dependencies between variables such that only the actual values of variables need to be maintained by the user interface. For example, when a particular user wishes to update monitor settings, the user interface only needs to pass these settings to the semantic module. The semantic module would provide feedback as to whether the new settings disrupt the dependencies.

The semantic module may output the status of the device or portion of the system it maintains.

For example, a monitor semantic module (i.e., a semantic module dedicated to a computer monitor) may provide feedback for proposed changes to other variables based on the input changes to settings.

As a configuration structure is adapted for a particular application, many semantic interconnections must be considered which are detected only in later stages of the software development and which then may generate a representation of the interconnections in the user interface of the software system. Semantic modules may provide maintenance for the interconnections, and may aid in keeping systems more stable.

As used hereinbefore, the term module may represent a block or segment of computer executable code, or a separate entity to execute the functionality described. As such, example embodiments including modules should not be limited to devices employing only electrical hardware, but also to devices and computer readable mediums including computer executable software and/or program code to mimic the functionality of example embodiments.

Therefore, example embodiments of the present invention may be implemented, in software, for example, as any suitable computer program which may be stored on a computer-readable storage medium. The computer program may include code or logic code portions embodied thereon for, when executed on a computer device (any device with a processor), to enable the computer device to execute one or more functions of one or more example methodologies, or derivations thereof, described above.

The computer-readable storage medium may be a built-in medium installed inside a computer main body or removable medium arranged so that it can be separated from the computer main body. Examples of the built-in medium include, but are not limited to, rewriteable non-volatile memories, such as RAMs, ROMs, flash memories, and hard disks. Examples of a removable medium may include, but are not limited to, optical storage media such as CD-ROMs and DVDs; magneto-optical storage media such as MOs; magnetism storage media such as floppy disks (trademark), cassette tapes, and removable hard disks; media with a built-in rewriteable non-volatile memory such as memory cards; and media with a built-in ROM, such as ROM cassettes.

These programs may also be provided in the form of an externally supplied propagated signal and/or a computer data signal (e.g., wireless or terrestrial) embodied in a carrier wave. The computer data signal embodying one or more instructions or functions of an example methodology may be carried on a carrier wave for transmission and/or reception by an entity that executes the instructions or functions of the example methodology. For example, the functions or instructions of the example embodiments may be implemented by processing one or more code segments of the carrier wave, for example, in a computer, where instructions or functions may be executed for simulating arbitrary software and/or unmodified code directly on a host processor, in accordance with example embodiments of the present invention.

Further, such programs, when recorded on computer-readable storage media, may be readily stored and distributed. The storage medium, as it is read by a computer, may enable the methodology of maintenance of dependent variables directly on a host processor, in accordance with the example embodiments of the present invention.

Example embodiments of the present invention being thus described, it will be obvious that the same may be varied in many ways. For example, the methods according to example embodiments of the present invention may be implemented in hardware and/or software. The hardware/software implementations may include a combination of processor(s) and article(s) of manufacture. The article(s) of manufacture may further include storage media and executable computer program(s), for example, a computer program product stored on a computer readable medium.

The executable computer program(s) may include the instructions to perform the described operations or functions. The computer executable program(s) may also be provided as part of externally supplied propagated signal(s). Such variations are not to be regarded as departure from the spirit and scope of the present invention.

Although example embodiments of the present invention have been shown and described with regard to certain operations (e.g., S100, S200, and/or S300 of FIG. 8) being performed serially or consecutively, it will be understood that any combination of these operations and/or any combination of variations of these operations may be performed simultaneously and in parallel.

Although specific aspects may be associated with specific example embodiments of the present invention, as described herein, it will be understood that the aspects of the example embodiments, as described herein, may be combined in any suitable manner.

Therefore, the present invention being thus described, it will be obvious that the same may be varied in many ways. Such variations are not to be regarded as a departure from the invention, and all such modifications as would be obvious to one skilled in the art are intended to be included within the scope of the following claims.

What is claimed is:

1. A semantic module for maintaining dependencies between variables of a user equipment, the semantic module comprising:
a first database to store the variables and information correlating to the dependencies between the variables;
an interface to receive at least one proposed change to at least one of the variables; and
a decision module to determine whether the at least one proposed change to the at least one of the variables is acceptable.

2. The semantic module of claim 1, wherein the information correlating to the dependencies between the variables includes at least one of a set of relationships between the variables and functions of values of the variables.

3. The semantic module of claim 1, wherein:
the information correlating to the dependencies between the variables includes at least one of a set of relationships between the variables and functions of values of the variables; and
the set of relationships between the variables includes subsets of variables dependent upon each other.

4. The semantic module of claim 1, wherein:
the information correlating to the dependencies between the variables includes at least one of a set of relationships between the variables and functions of values of the variables; and
the functions of the values of the variables include at least one function describing a mathematical relationship between variables.

5. The semantic module of claim 1, wherein the interface includes an inward communication channel and an outward communication channel.

6. The semantic module of claim 1, wherein:
the interface includes an inward communication channel and an outward communication channel; and
the proposed changes are received through the inward communication channel.

7. The semantic module of claim 1, wherein:
the interface includes an inward communication channel and an outward communication channel; and
the determination is output through the outward communication channel.

8. The semantic module of claim 1, wherein the decision module determines whether the proposed changes to the variables are acceptable based on the variables and information in the first database.

9. The semantic module of claim 1, wherein the decision module is further used to output the determination representing whether or not the at least one proposed change is acceptable.

10. The semantic module of claim 1, wherein the decision module is further used to output the determination as at least one of a flag and warning, upon the at least one proposed change not being acceptable.

11. The semantic module of claim 1, wherein the decision module is further used to output a potential change to a different variable to maintain a stable system, upon the at least one proposed change not being acceptable.

12. The semantic module of claim 1, wherein:
the decision module outputs the determination as a set of values for the variables;
the set of values of the variables includes the at least one proposed change if the at least one proposed change to the at least one of the variables is acceptable; and
the set of values of the variables includes an alternate acceptable value if the at least one proposed change to the at least one of the variables is not acceptable.

13. The semantic module of claim 1, wherein:
the at least one proposed change includes a plurality of proposed changes; and
the at least one variable includes a plurality of variables, at least two of the variables each including one of the plurality of proposed changes.

14. The semantic module of claim 1, further comprising a second database to store at least one of the variables and information correlating to the dependencies between the variables.

15. A method of maintaining dependencies between variables of a user equipment, the method comprising:
receiving at least one proposed change to at least one of the variables of the user equipment;
searching a database for information correlating to the dependencies of the at least one variable for which the at least one proposed change is received; and
determining whether the at least one received proposed change to the at least one variable is acceptable based upon the information searched from the database.

16. The method of claim 15, wherein the receiving comprises receiving proposed changes through an inward communication channel.

17. The method of claim 15, wherein the searching comprises:
locating stored values in the database for the at least one variable for which the at least one change is received; and
identifying a set of variables dependent on the at least one proposed change.

18. The method of claim 15, wherein the information correlating to the dependencies of the variables is at least one of a set of relationships between the variables and functions of the values of the variables.

19. The method of claim 15, wherein the information correlating to the dependencies of the variables is at least one of a set of relationships between the variables and functions of the values of the variables and the determining comprises:
replacing, temporarily, at least one variable with the at least one proposed changed variable;
determining, if a result of the at least one change violates the set of relationships between the variables; and
admitting the replaced at least one variable upon the determination indicating that the set of relationships is not violated.

20. The method of claim 15, wherein the information correlating to the dependencies of the variables is at least one of a set of relationships between the variables and functions of the values of the variables and the determining comprises:
replacing, temporarily, a plurality of variables with a plurality of proposed changed variables;
determining if the replaced variables violate the functions of the values of the variables; and
admitting the replaced variables upon the determination indicating that the set of relationships is not violated.

21. The method of claim 15, further comprising:
outputting the determination, representing whether or not the at least one proposed change is acceptable.

22. The method of claim 15, further comprising:
outputting the determination as at least one of a flag and warning, upon the at least one proposed change not being acceptable.

23. The method of claim 15, further comprising:
outputting a potential change to a different variable to maintain a stable system, upon the at least one proposed change not being acceptable.

24. A computer readable medium including program segments for, when executed on a computer device, causing the computer device to implement the method of claim 15.

25. A system comprising a plurality of semantic modules as claimed in claim 1.

26. The system of claim 25, further comprising a user interface.

27. A system, comprising:
a plurality of semantic modules for maintaining dependencies between variables of a plurality of user equipment, each of the plurality of semantic modules including,
a first database to store the variables and information correlating to the dependencies between the variables,
an interface to receive at least one proposed change to at least one of the variables, and
a decision module to determine whether the at least one proposed change to the at least one of the variables is acceptable; and
a user interface, the user interface including a back end portion and a front end portion; wherein,
the front end portion is arranged to communicate with the back end portion, and
the back end portion is arranged to communicate with the plurality of semantic modules.
